(19) United States
(12) Patent Application Publication
(10) Pub. No.: US 2014/0310175 A1
(43) Pub. Date: Oct. 16, 2014

(54) SYSTEM AND DEVICE FOR EXCHANGING CLOUD-BASED DIGITAL PRIVILEGES

(71) Applicant: Jack Bertram Coronel, Las Vegas, NV (US)

(72) Inventor: Jack Bertram Coronel, Las Vegas, NV (US)

(21) Appl. No.: 14/252,108

(22) Filed: Apr. 14, 2014

Related U.S. Application Data
(60) Provisional application No. 61/811,687, filed on Apr. 12, 2013.

(51) Int. Cl. G06Q 20/04; G06Q 20/40

(52) U.S. Cl. CPC G06Q 20/0453; G06Q 20/40
USPC 705/44

(57) ABSTRACT

A system includes one or more processors and computer-readable storage media storing instructions executable by a processor to storing a digital privilege in a cloud data store that is accessible by terminals which create the digital privilege and access rights associated therewith. When a request to exchange the access rights to the digital privilege for the digital privilege, or an attribute thereof, is received, the exchange is authorized based on satisfaction of one or more exchange criteria and the access rights are exchanged for the digital privilege (or an attribute associated therewith) while the digital good remains in the cloud data store. The access rights are deleted from the account of the user.

### RELATED APPLICATION DATA

The present application claims the priority of U.S. Provisional Application Ser. No. 61/811,687, entitled “System and Device for Cloud-based Data Management,” filed Apr. 12, 2013 by Applicants herein.

### FIELD OF THE INVENTION

The present invention relates to systems, devices, and methods for providing access to digital privileges. More specifically, the present invention includes systems, devices, and methods for exchanging access rights to digital privileges without duplicating or transferring the digital privilege.

### BACKGROUND OF THE INVENTION

Tickets, vouchers, bearer bonds, and the like are a form of entitlement or right that must be physically possessed to receive the benefit of the entitlement or right. Put another way, the holder of the ticket, voucher, coupon, bearer bond, or the like receives the benefit of the entitlement or right, regardless of whether the holder is the rightful owner of the ticket, voucher, bearer bond, or the like.

One industry which uses vouchers extensively is the casino gaming industry. A system referred to as “ticket-in, ticket out” or “TITO” has widely replaced the cash transactions formerly used by electronic gaming machines (“EGMs”). In the TITO system, EGMs receive cash or tickets for play. Upon triggering a “cash out” event at the EGM, a ticket printer integrated into the EGM issues a ticket. The ticket includes a code (such as a bar code) to identify the ticket. The EGM simultaneously transmits a signal to record the ticket in a database. Tickets may be used at other EGMs equipped with ticket readers, which are associated with the same database. That is, one limitation upon the use of tickets is that a ticket issued by EGMs in one casino are not usable in EGMs in a different casino.

Additionally or alternatively, tickets may be redeemed at kiosks. The ticket is inserted into the ticket reader at the kiosk, which reads the code printed on the ticket. After verification via the database, the value associated with the ticket is dispensed in the form of cash.

As noted above, one drawback of the TITO system is that the tickets are limited to the database associated with the ticket, i.e., tickets issued by one casino are not usable in a different casino. Another drawback of the TITO system is that the ticket may be used by the holder of the ticket, regardless of whether the ticket-holder is the rightful owner of the ticket. Thus, there is no mechanism within the TITO system of prevent the redemption or use of lost or stolen tickets.

### SUMMARY OF THE INVENTION

The present invention includes a system and computer-readable medium for carrying out a process. In one optional embodiment, a system includes one or more processors and computer-readable storage media encoded with instructions that, when executed on the one or more processors, instruct the one or more processors to perform acts for enabling the permissible exchange of access rights to digital privileges by a user having an account stored at a network resource server accessible by cloud-enabled devices.

A digital privilege is created at a terminal. The digital privilege is a digital privilege in which the user has legitimately obtained access rights. In an optional embodiment, the digital privilege is associated with at least one attribute selected from the group consisting of a value, a good, and a service. Additionally, access rights to the digital privilege are created at the terminal.

The digital privilege is transmitted from the terminal to a cloud data store, where it is stored. Similarly, the access rights to the digital privilege are stored in an account of the user in the network resource server. The access rights stored in the account of the user determine the user's access to the digital privilege. Specifically, the digital privilege in the cloud data store is accessible by a cloud-enabled device through the account of the user.

A request is received to exchange the access rights to the digital privilege for the attribute associated with the digital privilege. An exchange of the access rights to the digital privilege for the attribute associated with the digital privilege is authorized based on satisfaction of one or more exchange criteria. Upon authorization of the request to exchange the access rights to the digital privilege for the attribute associated with the digital privilege, the access rights to the digital privilege are from the account of the user are exchanged for the attribute associated with the digital privilege. In an optional embodiment, the digital privilege remains in the cloud data store without transferring the digital privilege before, during, or after the exchange.

After exchanging the access rights to the digital privilege for the attribute associated with the digital privilege, the access rights to the digital privilege are deleted from the account of the user, thereby excluding the account associated with the user from the digital privilege.

In an optional embodiment, access rights are transferrable. In one such optional embodiment, prior to receiving a request to exchange the access rights to the digital privilege for the attribute associated with the digital privilege, a request is received to transfer the access rights to the digital privilege to a transferee account associated with a transferee. That is, the digital privilege is a digital privilege in which the transferee has legitimately obtained access rights such as through a legitimate transfer request.

The access rights to the digital privilege are stored in the transferee account in response to the request to transfer the access rights to the digital privilege. Again, the access rights stored in the transferee account determine the transferee's access to the digital privilege such that the digital privilege in the cloud data store is accessible by a cloud-enabled device through the transferee account. After transferring the access rights to the digital privilege, the access rights to the digital privilege are deleted from the account of the user, thereby excluding the account associated with the user from the digital privilege.

### BRIEF DESCRIPTION OF THE DRAWINGS

FIG. 1 is a block diagram of a system according to an embodiment of the present invention;

FIG. 2 is a flowchart of a method according to an embodiment of the present invention;

FIG. 3 is a block diagram of a system according to an embodiment of the present invention.

### DESCRIPTION

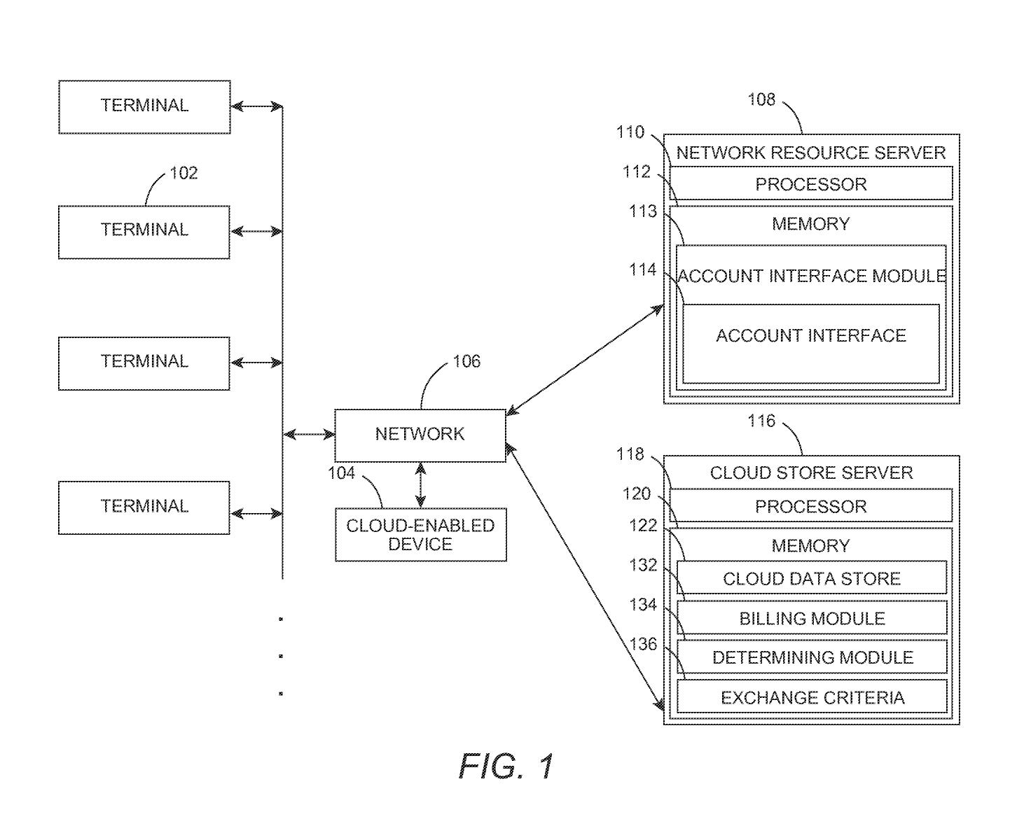

Reference is now made to the figures wherein like parts are referred to by like numerals throughout. As illustrated in FIG. 1, a system according to an embodiment of the present invention includes a terminal 102 to access a network 106 and establish communication with a network resource server 108 implementing a network resource, e.g., a website, database, or the like. It is contemplated that any quantity of terminals 102 may be provided. Terminals 102 may take any form, including a personal computer, entertainment system, PDA, mobile phone, tablet device, e-reader, kiosk, game console, electronic gaming machine (“EGM”), electronic table-game system (“ETS”), or other computing device that is configured to communicate over a network. In an optional embodiment, terminals 102 execute program instructions which result (or may result) in the generation of a digital privilege. The digital privilege includes an attribute. For example, in an optional embodiment, the attribute may include one or more of a value, a good, and/or a service.

Thus, in one such optional embodiment, each digital privilege is associated with a value. The value may take any form, including an exchange value. In various examples, the value may be expressed as a monetary value, point value, feature value, chance value, product or service value, status value, or the like. In an additional or alternate optional embodiment, each digital privilege may be associated with a right to a good and/or service which may be exchanged for goods (whether physical or digital), services, chances, status, or the like.

In an optional embodiment, a digital privilege may additionally be associated with a transaction history, access history, forensic trail, change or modification history, status history and options, relationships to other digital privileges and/or other access rights, share status, or the like.

Each digital privilege is associated with access rights. In an optional embodiment, the access rights are created by the terminal when the digital privilege is generated. The access rights define scope of access and/or use of the digital privilege. For example, access rights could define cloud-enabled devices and/or users of cloud-enabled devices having the right to access the digital privilege. Additionally or alternatively, access rights could define the scope of use of the digital privilege by cloud-enabled devices and/or users of cloud-enabled devices (described in greater detail below).

A network 106 allows communication between user devices 104 and servers, such as a network resource server 108. A network 106 may be any type of communication network, including the Internet, a local area network (“LAN”), a wide area network (“WAN”), a wireless wide area network, a cable television network, a wireless network, a telephone network, or the like.

A system optionally includes a network resource server 108. A network resource server 108 may be either a single server or a larger collection of servers, such as a data center or multiple data centers. A network resource server 108 may include one or more processors 110 and a memory 112. The memory 112 may take any form of computer-readable storage media including, but not limited to, optical data storage, magnetic data storage, random access memory, read-only memory, electrically erasable programmable read-only memory (EEPROM), flash memory or other solid-state memory, or any other medium which can be used to store information which is accessible to a processor 110. The processor 110 is configured to execute instructions stored in the memory 112. In one such optional embodiment, the network resource server 108 stores accounts for users. In such an optional embodiment, access rights for digital privileges are stored in accounts. More specifically, the access rights for a user's digital privileges are stored in an account for that user. For example, an account interface module 113 may be stored in memory 112 and executed by the processor 110 to provide an account interface 114 to a user. The account interface 114 provides access functionality to users of an account accessible through the network resource server 108 via a network 106.

A system includes a cloud data store 122 in communication with the terminal. In an optional embodiment, the cloud data store 122 is provided in a cloud store server 116. A cloud store server 116 may be located on the same or a separate server as the network resource server 108 and may also include either a single server, or a larger collection of servers, such as a data center or multiple data centers. A cloud store server 116 may include one or more processors 118 and a memory 120, the memory including one or more computer-readable storage media. A processor 118 is configured to execute instructions stored in the memory 120.

In one optional embodiment, a terminal 102 creates a digital privilege for storage on the cloud data store 122 or instructs the cloud store server 116 to create and store a digital privilege. In an optional embodiment, the digital privilege(s) are stored in general storage, i.e., undifferentiated without respect to specific access rights.

A system includes a cloud-enabled device 104. In an optional embodiment the terminal 102 and the cloud-enabled device 104 may be the same device. In an alternate embodiment, the terminal 102 and cloud-enabled device 104 may be separate. In an optional embodiment, a plurality of cloud-enabled devices 104 may be provided. The cloud-enabled device 104 is configured to communicate with the cloud data store 122 and the network resource server 108 and access digital privileges stored thereon.

For example, in one optional embodiment, stored within memory 120 is a cloud data store 122 associated with a plurality of user accounts which are, as noted above, stored at a network resource server 108. As shown in the illustrated example, a single cloud data store 122 stores a plurality of digital privileges. As noted above, in one optional embodiment, digital privileges are not created by the cloud data store, but are created by terminals 102 and transmitted to the cloud data store 122 for storage. It is contemplated that the digital privilege may be undifferentiated insofar as the digital privileges may simply be a pool of attributes which are not differentiated except as to the access rights associated therewith with shared access among all users possessing access rights to the digital privilege. For example, many users may each have rights to a various values identified by each user's access rights, while the cloud data store simply stores the aggregate value. In one such example, the cloud data store stores $100, with a first user's access rights identifying his entitlement to $30 of that value, a second user's access rights identify her entitlement to $20 of that value, and a third user's access rights identifying her entitlement to $50 of that value. While the cloud data store 122 is illustrated as a single memory 120, it is contemplated that the cloud data store 122 may be distributed across multiple separate memories residing on the same or different servers or in remote data storage accessible to the cloud store server 116. In some embodiments, a billing module 132 may be configured to levy a fee upon exchange of access rights to a digital privilege. A determining module 134 may be configured to determine whether to permit or deny exchange of the access rights to a digital privilege according to one or more exchange criteria 136.

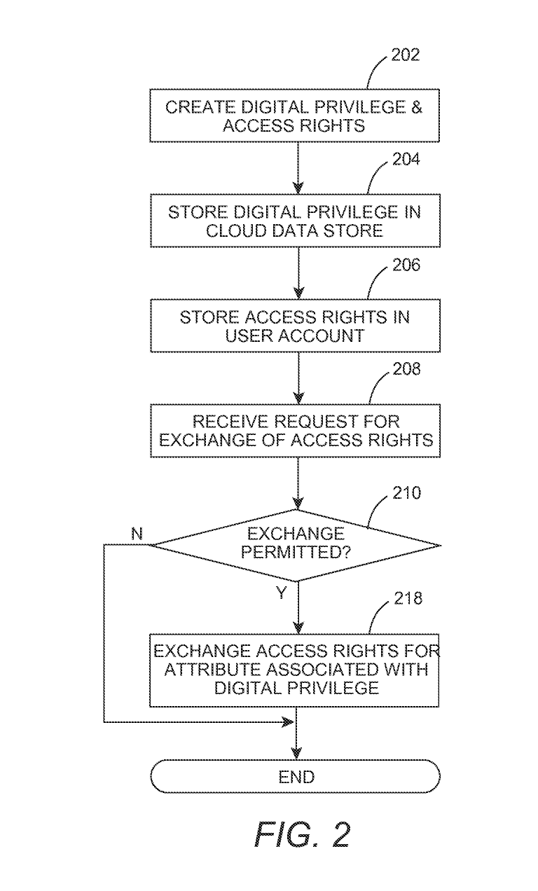

According to an embodiment of a method of the present invention, illustrated in FIG. 2, a digital privilege may be created through a transaction at a terminal 102. The terminal 102 could take any form, such as a kiosk, mobile device, personal computer, EGM, ETS, handheld device, point of sale terminal, or the like. Similarly, a transaction could take any form including an exchange, purchase, redemption, reward, promotion, cash-out from game play, conversion, gift and/or share, or the like.

In one such example, a terminal 102 could be used to create 202 a digital privilege in response to use of the terminal 102 by a user. The interaction between the user and the terminal 102 could take place through a user interface at the terminal to create a digital privilege and spawn a value associated therewith. For example, a user could, through a terminal, exchange currency or other medium of exchange to create an attribute, such as a value, good, or service, associated with a digital privilege. In other examples, the attribute associated with a digital privilege could arise through converting an attribute in one form to create an attribute associated with a digital privilege, create a value associated with a digital privilege as a result of a purchase, redeem a right to an attribute which is fulfilled by creating an attribute associated with a digital privilege, create an attribute associated with a digital privilege in response to cashing out an attribute (such as game credits) usable for game play, access an attribute associated with a digital privilege that was created as a result of a reward from a party other than the user, access an attribute associated with a digital privilege that was be created as a gift or share from a party other than the user, create an attribute associated with a digital privilege for another user through gifting or sharing, access an attribute associated with a digital privilege that was set by a party other than the user as a promotion, or the like.

A terminal 102 may also enable the association of access rights with the digital privilege and/or the attribute associated with a digital privilege. Optionally, access rights may include the right to, for example, use an attribute associated with a digital privilege, trade an attribute associated with a digital privilege, exchange an attribute associated with a digital privilege, gift and/or share an attribute associated with a digital privilege, monitor an attribute associated with a digital privilege, regulate an attribute associated with a digital privilege, track an attribute associated with a digital privilege, alter or modify an attribute associated with a digital privilege, administer an attribute associated with a digital privilege, access an attribute associated with a digital privilege, or the like. Additionally or alternatively, access rights may include the right to, for example, create access rights, transfer access rights, use access rights, trade access rights, exchange access rights, gift and/or share access rights, monitor access rights, regulate access rights, track access rights, alter or modify access rights, administer access rights, or the like. Thus, in one optional embodiment, various different entities may have concurrent access rights in a digital privilege with, for example, a user having certain access rights, a regulatory body having certain access rights, a provider of goods and/or services having certain access rights, an administrator having certain access rights, and so forth. It is contemplated that the concurrent access rights in a digital privilege in such an optional embodiment may be the same (or different) in whole or in part.

In an optional embodiment, the terminal 102 communicates with a cloud data store 122 to store 204 a digital privilege at the cloud data store. Alternatively, the terminal 102 communicates with a cloud data store 122 to cause the cloud data store to create a digital privilege for storage 204 at the cloud data store 122. A cloud data store 122 in an optional embodiment herein is a storage device that is generally accessible to cloud-enabled devices 104, as described in greater detail below, via a network 106. In an optional embodiment, a cloud data store 122 may take the form of a file server, remote data storage, or the like.

The cloud data store stores 122 digital privileges in undifferentiated storage. That is, the cloud data store 122 stores digital privileges in general storage without segregating digital privileges into accounts based on access rights and/or users holding access rights.

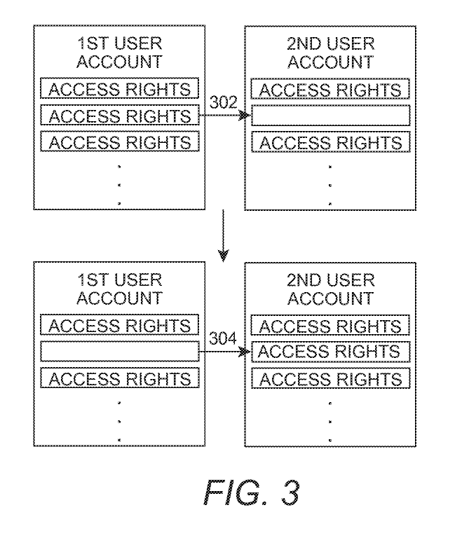

Similarly, access rights to the digital privileges are stored 206 in an account stored at a network resource server 108. In an optional embodiment, accounts may be pre-existing accounts, such as membership accounts, loyalty and/or reward accounts, or the like. In an optional embodiment, accounts may be differentiated by associating each account with a user and/or user device. That is, a first user may have an account associated with the first user, while a second user may have a different account associated with the second user. As may be appreciated, in an optional embodiment, access rights to a digital privilege may be transferrable between accounts of different users. For example, in the optional embodiment illustrated in FIG. 3, a request to transfer 302 access rights from the account of a first user to the account of a second user results in the removal of the access rights from the account of the first user and the addition 304 of the access rights to the account of the second user. In this manner, the access rights are not retained by the transferring user and are only usable by the transferee user.

Cloud-enabled devices 104 communicate with the cloud data store 122 and the network resource server 108, optionally via a network 106. Cloud-enabled devices 104 could take any form, including kiosks, mobile devices, handheld devices, tablet devices, personal computers, point of sale terminals, electronic gaming machines, a combination of any of the preceding, or the like.

The digital privileges stored on the cloud data store 122 are generally available to cloud-enabled devices 104, but for a cloud-enabled device 104 to access a digital privilege and/or the value or other attributes associated with the digital privilege, the cloud-enabled device 104 must utilize the access rights associated with that digital privilege. That is, the access rights associated with a digital privilege must comport with access rights granted to a cloud-enabled device 104 for the cloud-enabled device 104 to access the digital privilege. In such an optional embodiment, if the access rights granted to a cloud-enabled device 104 do not comport with the access rights associated with a digital privilege, that digital privilege is not accessible to that cloud-enabled device 104. More specifically, a cloud-enabled device 104 may access an account stored at a network resource server 108. In an optional embodiment, the cloud-enabled device 104 may be verified such as through a username, password, personal identification number (“PIN”), or the like. By accessing the account, the cloud-enabled device 104 may utilize the access rights stored within the account to access the digital privilege(s) associated with those access rights. However, those digital privileges not associated with the access rights stored in the account are not accessible to the cloud-enabled device 104.

The type and nature of access permitted to be exercised by a cloud-enabled device 104 would be defined by the access rights granted to that cloud-enabled device. It is contemplated that different access rights to the same digital privilege could be granted to different cloud-enabled devices 104 by storing access rights in multiple accounts. For example, certain cloud-enabled devices 104, such as those accessing through accounts used by casino operators, could be permitted to exercise different access rights than other cloud-enabled devices 104, such as those accessed through accounts used by users or regulators, even though that variety of granted access rights may be associated with the same digital privilege. Thus, in one such embodiment, a cloud-enabled device 104 may utilize the access rights in a user's account to transmit a request to, for example, use, convert, exchange, gift, share, or redeem the access rights associated with a digital privilege for the digital privilege. Similarly, a cloud-enabled device 104 may utilize the access rights in a casino operator's account to transmit a request to, for example, view, modify, track, or administer the same digital privilege, while a cloud-enabled device 104 may utilize the access rights in a regulator's account to transmit a request to audit, regulate, and monitor that same digital privilege. It is noted that the phrase “same digital privilege” refers primarily to the fact that the digital privilege accessible to the various cloud-enabled devices 104 is stored in a single location (although backups or the like may be made) so that the cloud-enabled devices 104 access the same data without copying or moving the data in any permanent manner. Such an embodiment could be adopted to reduce the risks or effects of piracy, data theft, unauthorized access, or the like.

Thus, in one example, a request may be received 208 to exchange the access rights associated with a digital privilege for the digital privilege (or an attribute associated with the digital privilege, such as the value associated therewith). A determination may be made 210 of whether the exchange is permitted. In an optional embodiment, the determination may be based on exchange criteria. For example, the user, the account, the access rights, and/or the digital privilege may be verified to determine if the exchange is permitted. If, for example, the account is not authorized to request an exchange or the digital privilege is unavailable for exchange, the exchange may be denied. Conversely, if the exchange is permitted, the access rights to the digital privilege may be exchanged 218 for the digital privilege (or an attribute associated therewith). Specific examples of exchanges are provided below.

In certain optional embodiments, an exchange may exhaust the digital privilege and it may not be available for further use. For example, if a digital privilege is associated with a right to be paid a certain value, once the exchange occurs and the value is paid, the digital privilege is no longer available for further exchange. However, for regulatory, record-keeping, or other reasons, it may be desirable to retain the digital privilege at the cloud data store 122. In one such optional embodiment, the access rights to the digital privilege may be deleted from the account associated with a user, thereby preventing that account from accessing (e.g., exchanging access rights for) the digital privilege.

In an example of a method according to an embodiment of the present invention, a digital privilege may be created at a terminal, such as a point of sale terminal or kiosk at a casino cashier cage, electronic gaming device, mobile or tablet device, or the like. As discussed above, the digital privilege may be created as the result of, for example, exchanging currency for a value associated with that digital privilege or cashing out stored game credits from an electronic device. The user, i.e., the person whose transaction created the digital privilege may have access rights to, as discussed above, use, transfer, exchange, convert, share, gift, or otherwise exercise ownership of the value associated with the digital privilege. In an optional embodiment, the user would exercise such access rights through a cloud-enabled device. Thus, the user could transfer the value associated with the digital privilege to another user. Similarly, the user could convert the value associated with the digital privilege to currency, credit, or points usable for purchase of goods and services (optionally in a separate, but connected, system). In another optional embodiment, the user could use the value for wagers in an electronic gaming device or convert the value to a chance or achievement usable for eligibility in games in an electronic gaming device. Any other of the access rights associated with the digital privilege could be exercised in a similar manner.

Concurrently, other entities could have access rights to the same digital privilege. Thus, in the example, the operator could administer, track, and/or modify the digital privilege, as well as the transaction history, access history, or other attributes associated with that digital privilege. Similarly, a regulator could monitor and regulate the digital privilege, as well as the forensic trail, change or modification history, or other attributes associated with that digital privilege.

In an optional embodiment, a digital privilege may be associated with dynamic access rights that may change, modify, or evolve. The changes, modifications, evolutions, or the like in dynamic access rights may occur due to any factor. For example, access rights may change, modify, evolve, or the like based on time, based on type or quantity of activity, based on type or quantity of access, or based on any other basis.

As may be appreciated, other records could be available through such a cloud data store in a similar manner. For example, universal player history records could be maintained without respect to the particular location or device where the player played. Similarly, universal electronic gaming machine history records could be maintained without respect to the particular location where the electronic gaming machine is located. Such records could be accessed through cloud-enabled devices in accordance with the access rights associated with those records and the access rights held by the cloud-enabled device.

While certain embodiments of the present invention have been shown and described it is to be understood that the present invention is subject to many modifications and changes without departing from the spirit and scope of the claims presented herein.

I claim:

1. A system comprising:
one or more processors; and
computer-readable storage media encoded with program instructions that, when executed on the one or more processors, instruct the one or more processors to perform acts for enabling permissible exchange of access rights to digital privileges by a user having an account stored at a network resource server accessible by cloud-enabled devices, the acts comprising:
creating a digital privilege at a terminal, wherein the digital privilege is associated with at least one attribute selected from the group consisting of a value, a good, and a service;
creating access rights to the digital privilege at the terminal;
transmitting the digital privilege from the terminal to a cloud data store;
storing the digital privilege obtained from the terminal in the cloud data store;
storing the access rights to the digital privilege in an account of the user in the network resource server, wherein the access rights stored in the account of the user determine the user's access to the digital privilege such that the digital privilege in the cloud data store is accessible by a cloud-enabled device through the account of the user, and wherein the digital privilege is a digital privilege in which the user has legitimately obtained access rights;
receiving a request to exchange the access rights to the digital privilege for the attribute associated with the digital privilege;
authorizing exchange of the access rights to the digital privilege for the attribute associated with the digital privilege based on satisfaction of one or more exchange criteria;
upon authorization of the request to exchange the access rights to the digital privilege for the attribute associated with the digital privilege, exchanging the access rights to the digital privilege from the account of the user for the attribute associated with the digital privilege while the digital privilege remains in the cloud data store without transferring the digital privilege; and
after exchanging the access rights to the digital privilege for the attribute associated with the digital privilege, deleting the access rights to the digital privilege from the account of the user, thereby excluding the account associated with the user from the digital privilege.

2. The system of claim 1 wherein the program instructions further comprise:
prior to receiving a request to exchange the access rights to the digital privilege for the attribute associated with the digital privilege, receiving a request to transfer the access rights to the digital privilege to a transferee account associated with a transferee;
storing the access rights to the digital privilege in the transferee account in response to the request to transfer the access rights to the digital privilege, wherein the access rights stored in the transferee account determine the transferee's access to the digital privilege such that the digital privilege in the cloud data store is accessible by a cloud-enabled device through the transferee account, and wherein the digital privilege is a digital privilege in which the transferee has legitimately obtained access rights; and
after transferring the access rights to the digital privilege, deleting the access rights to the digital privilege from the account of the user, thereby excluding the account associated with the user from the digital privilege.

3. A system comprising:
a terminal configured to execute program instructions to create a digital privilege, wherein the digital privilege is associated with at least one attribute selected from the group consisting of a value, a good, and a service, and create access rights to the digital privilege, wherein the digital privilege is a digital privilege in which the user has legitimately obtained access rights;
a cloud data store in communication with the terminal, wherein the cloud data store is configured to execute program instructions to receive the digital privilege from the terminal and store the digital privilege obtained from the terminal in the cloud data store;
a cloud-enabled device in communication with the cloud data store;
a network resource server in communication with the terminal and the cloud-enabled device, wherein the network resource server stores an account and is configured to execute program instructions to conduct steps comprising:
storing the access rights to the digital privilege received from the terminal in the account, wherein the access rights stored in the account determine the access to the digital privilege such that the digital privilege in the cloud data store is accessible through the account containing the access rights associated with the digital privilege;
receiving a request to exchange the access rights to the digital privilege for the attribute associated with the digital privilege;
authorizing exchange of the access rights to the digital privilege for the attribute associated with the digital privilege based on satisfaction of one or more exchange criteria;
upon authorization of the request to exchange the access rights to the digital privilege for the attribute associated with the digital privilege, exchanging the access rights to the digital privilege from the account for the attribute associated with the digital privilege while the digital privilege remains in the cloud data store without transferring the digital privilege; and
after exchanging the access rights to the digital privilege for the attribute associated with the digital privilege, deleting the access rights to the digital privilege from the account, thereby excluding the account from the digital privilege.

4. The system of claim 3 wherein the program instructions executable by the network resource server further comprise:
prior to receiving a request to exchange the access rights to the digital privilege for the attribute associated with the digital privilege, receiving a request to transfer the access rights to the digital privilege to a transferee account associated with a transferee;
storing the access rights to the digital privilege in the transferee account in response to the request to transfer the access rights to the digital privilege, wherein the access rights stored in the transferee account determine the transferee's access to the digital privilege such that the digital privilege in the cloud data store is accessible by a cloud-enabled device through the transferee account, and wherein the digital privilege is a digital privilege in which the transferee has legitimately obtained access rights; and
after transferring the access rights to the digital privilege, deleting the access rights to the digital privilege from the account of the user, thereby excluding the account associated with the user from the digital privilege.
